(19) United States
(12) Patent Application Publication
(10) Pub. No.: US 2010/0164876 A1
(43) Pub. Date: Jul. 1, 2010

(54) DATA INPUT DEVICE

(75) Inventor: Mark Stephen Dressell, Staines (GB)

Correspondence Address: HAYNES AND BOONE, LLP;IP Section, 2323 Victory Avenue, Suite 700, Dallas, TX, 75219, US

(73) Assignee: KEY FUTURES LIMITED, STAINES, SURREY (GB)

(21) Appl. No.: 12/303,920

(22) PCT Filed: Jun. 11, 2007
(86) PCT No.: PCT/GB07/02132

§ 371 Date: Dec. 8, 2008

(30) Foreign Application Priority Data
Jun. 12, 2006 (GB) 0611575.2

(51) Int. Cl. G06F 3/041; G06F 3/033

(52) U.S. Cl. 345/173; 345/179; 715/863

(57) ABSTRACT

A data input device comprising a data input interface comprising user selectable zones arranged to define one or more fixed points, each of the fixed points being a point around which three or more of the zones are arranged. The device is arranged to associate a sequential selection of zones with an input code. The sequential selection comprises a clockwise and/or anticlockwise consecutive selection of the zones around at least one of the fixed points.

### FIELD

The present invention relates to a data input device, in particular a data input device that can be used with a data processing apparatus such as a computer or handheld device to input data that might otherwise be input with another data input device such as a keyboard.

### BACKGROUND

Known data entry devices include a keyboard for a computers. Disadvantages of full scale keyboards include that they are not particularly portable, for example they typically require a flat surface and cannot typically be used as a handheld input device. For smaller electronic devices, for example handheld electronic devices such as personal digital assistants and pocket personal computers (PCs), known data entry devices include touch-sensitive keyboards and touch-sensitive handwriting recognition pads. Disadvantages of these data entry devices are that they can be slow, in terms of typical input speeds, and error prone. Known data input devices for mobile phones include keypads with 10 keys, one for each of the numbers 0 to 9, which are used to enter text by selecting a key one, two, three or four times, depending on the desired letter. Another known input device for mobile phones is a small-scale thumb operated QWERTY keypad. Again, data input on keypads can be slow and error prone.

Also, repetitive strain injuries have been associated with some known devices.

Furthermore, increasing miniaturisation, increasing power and decreasing cost of data processing devices mean more and more devices are being produced that are smaller than before and that can perform increasingly complex operations. There is therefore a need for an input device that can be used with such devices and that allows efficient entry of complex data, large volumes of text and control commands.

The present invention is made with the above considerations in mind.

### SUMMARY OF THE INVENTION

The present invention is defined in the accompanying claims

A data input device comprising a data input interface comprising user selectable zones arranged to define one or more fixed points is provided. Each of the fixed points is a point around which three or more of the zones are arranged. The device is arranged to associate a sequential selection of two or more zones with an input code. The sequential selection comprises a clockwise and/or anticlockwise selection of the two or more zones around at least one of the fixed points.

Embodiments of the present invention can provide the following advantages:

Embodiments can provide a versatile data input device which can accommodate the increasing power and functionality of data processing apparatus, particularly smaller apparatus where only a small space is available for the input device.

Embodiments can provide data input devices that are compact and therefore able to accommodate the continuing miniaturisation of data processing apparatus.

Embodiments can provide data input devices capable of delivering all the characters and commands found on a standard PC keyboard and with the ability to accommodate more characters, commands, symbols, etc.

By supporting distinct sequential selections or moves around the fixed points, very few fixed points are typically required enabling embodiments to be very small. In particular, allowing both clockwise and anticlockwise movement around the fixed points means very few fixed points may be required. Also, each zone may be used as the starting point for a move meaning again few fixed points may be required.

Embodiments may be small enough to fit onto an apparatus without interfering with the requirements of other controls, and/or small enough to be carried comfortably as a separate attachment.

Embodiments may be small and provide a simple method of operation. Therefore, embodiments can be operated whilst hand-held (i.e. not requiring a stable, flat surface such as a tabletop), can fit easily onto the surface of most portable microelectronic devices, or can be easily carried as a small plug in attachment.

Embodiments may be operated with only one hand.

Embodiments may be operated whilst standing, sitting or reclining.

Embodiments may be used in a confined space, for example where there is no convenient surface to place a laptop or keyboard.

Embodiments may satisfy the growing requirement to provide a level playing field for disabled users, and may accordingly provide accessibility to a wide range of disabled users.

Users without standard functionality in fingers and arms, or users required to wear heavy gloves can operate a larger embodiment, for example with a stylus adapted to the user's particular grip.

Embodiments can be used with the minimal of learning curves and may have clear diagrammatic support to indicate which part of the interface is to be used to input a particular character or command.

Embodiments may support a large number of unique sequential selections or moves that can be made around the fixed points. The number of unique moves may be sufficient to accommodate many more character and command keys than are found on a normal computer keyboard. Consequently full computer operation may be possible from a simple and single interface.

In embodiments the unique moves may be predefined and/or the user can associate their own codes with the unique moves.

Storing a variety of code associations to the unique sequential selections or moves allows the user to switch between sets of codes, enabling an almost limitless variety of codes to be sent to a data processing apparatus or host device.

Though many distinct moves can be made on embodiments, most moves follow simple patterns. All distinct moves can be easily read from small illustrative diagrams and once the user understands how to operate the interface they can be immediately productive, their speed increasing with familiarity.

Embodiments may enable the interface to make a sequential selection of the zones with continuous, economic, flowing movements that resemble the strokes, curves and loops used in handwriting, creating a unique style of uninterrupted, efficient, non-linear handwriting. Consequently it is comfortable to use, reducing likelihood of repetitive strain injuries and providing an input speed similar to handwriting.

Embodiments may provide an input speed fast enough to provide a medium level of data input such as note taking, e-mails and minor programming tasks, for example a speed similar to that of handwriting.

Embodiments may comprise an interface which contain guides (e.g. grooves, guides, indents, raised sections) to provide a tactile surface, thus enabling the user to know their location on the zone and the direction and distance of movement purely through tactile feedback. This enables the interface to be operated without the use of visual monitoring i.e. data can be input whilst looking at the data source and the user is not visually tied to the data input interface. In one embodiment the data input device has a raised area around each of the fixed points, or the fixed points are raised relative to the zones, to guide selection of the zones.

The user can develop ‘touch typing’ abilities on embodiments, for example those with a tactile surface.

Embodiments can be used to support cursor movement similar to that of a mouse or tracker ball.

Embodiments may be manufactured cheaply and easily and may be robust and durable.

Embodiments can be constructed which do not have mechanical working parts, making them extremely robust and durable and able to be used in extreme and hazardous environments.

Embodiments, particularly for portable devices, may also have one or more of the following characteristics robustness, durability, sufficient data input speed to meet the light to medium use of a portable device, avoidance of repetitive strain injuries, cheapness to manufacture and accessibility for a wide range of disabled users.

A variety of technologies can be used to build the embodiments, including touch sensitive materials, radio transmission and reception, electromagnetic induction, light sensitive devices, electromechanical contacts, etc. Whatever is chosen the small size and simple structure of embodiments can make manufacture highly cost effective.

### BRIEF DESCRIPTION OF THE DRAWINGS

Embodiments of the invention will now be described, by way of example only, with reference to the accompanying drawings in which:

FIG. 1a illustrate the layout of an example data input interface of a data input device constructed in accordance with an embodiment of the invention, together with the simple architecture of the device.

FIG. 1b illustrates the layout of the data input interface.

FIGS. 2a to 2f illustrate some examples of unique sequential selections or moves made on the data processing interface.

FIG. 3 illustrates how to change the starting zone/panel or focus on the data input interface.

FIGS. 4a and 4b illustrate an example of a modification to a unique sequential selection or move on the data input interface.

FIG. 5a is a reference diagram to show distinct sequential selections or moves that can be made on the data input interface.

FIG. 5b illustrates unique sequential selections or moves involving multiple fixed points.

FIG. 5c illustrates unique sequential selections or moves to provide cursor control.

FIG. 6 illustrates three unique sequential selections or moves combined to show non-linear handwriting.

FIG. 7 illustrate the tactile components of the data input interface.

FIG. 8A illustrates a sensor layout for the data input device.

FIG. 8B is a flow diagram illustrating the functionality of a computer program comprising computer code to process sequential selections received from the data input device.

FIG. 9 shows an alternative data input interface with additional input elements.

FIG. 10 shows an alternative data input interface with more fixed points.

FIG. 11 shows an alternative data input interface with less fixed points.

FIG. 12 shows an alternative data input interface with additional row of fixed points and additional zones/panels.

FIG. 13 shows an alternative data input interface with an extended run off area.

FIG. 14 shows an alternative data input interface with no run-off areas.

FIG. 15 shows another alternative data input interface with no run-off areas.

FIG. 16 shows another alternative data input interface with no run-off areas.

### DETAILED DESCRIPTION

FIG. 1a illustrates the layout of an example data input interface 10 of a data input device 18 constructed in accordance with an embodiment of the invention, together with the simple architecture of the device. The architecture comprises a processor 20 connected to each of the input interface 10, a memory 22 and a power supply 24. The depicted device is shown connected to a data processing apparatus 26 (a “host device”) such as a handheld PC.

Embodiments of the device may have their own processor, memory and/or power supply. Other embodiments may not have one or more of these components and may simply connect to or be part of a data processing apparatus which has its own processor, memory and/or power supply. The data input device may be connected as a peripheral to a host device or may be located on the device as one of its controls. Connections to the host device may be of any type, for example wire, radio and infrared.

The interface is divided into a grid of zones (or activation zones or panels) arranged around a series of fixed points. The boundaries between the zones or panels mark a convenient division of a full rotation around the associated fixed point. For example, four zone or panel borders may radiate from a fixed point marking approximate quarter turns around the associated fixed point.

A selection element, typically a stylus, may be moved around one or more fixed points to create a unique set of moves. Sensors built into the interface are arranged to detect the movement of the stylus around the fixed points and into run-off areas which may be associated with the zones or panels. The sensing of the stylus movement may be achieved by using touch sensitive material for the zones or panels and run-off areas. The completion of the set of moves is recognised either when the stylus returns to the zone or panel from which it started, or if a particular set of moves has been made from a known starting point.

Computer code (software) held in the memory is used by a processor to monitor the data returned by the sensors. Once the stylus has completed a unique, identifiable set of moves these are matched by the processor against a set of computer character and command codes stored in the memory. If the code requires a modification of the operating status such as the code for ‘caps lock’ then the operating status is modified appropriately. If the code is a ‘cumulative’ code requiring a string of codes to be collected before sending data to the host device, such as the code for ‘Ctrl’ then the codes are accumulated until the initial cumulative code is repeated, at which point the necessary command(s) or code(s) suitable to the host device are sent to the host device. If none of these conditions, or any other special conditions apply, then the code is sent to the host device. The computer program is then reset ready to record the next set of unique moves.

In one embodiment cumulative code strings can be preloaded into the input device so that if a cumulative code string matches a pre-loaded cumulative code string the input device is able to send the appropriate code or command to the host device without the user having to repeat the original cumulative code. For example, if the user completed the moves for the ‘Ctrl’ command and then the letter c (the windows cumulative code string for the copy command) then if a string of ‘Ctrlc’ was preloaded into the input device the copy command would be sent to the host device without the user having to repeat the move for the ‘Ctrl’ command.

The processor may also contain a timer, e.g. timing circuitry, so that the speed of moves can be taken into account when deciding which code to pass to the host device. A single touch, or series of touches on a zone or panel may also be interpreted as a particular request for action. By enabling the user to select any of the zones or panels as the starting point of the moves, the interface is capable of producing a wide range of unique moves.

Selecting the starting zone/panel may be achieved by moving the stylus into a run-off area alongside the required zone/panel. A second movement into any run-off area returns the starting point to the central zone/panel.

The size, layout and design of the interface enable it to be controlled by simple, flowing, handwriting-like movements. The necessary energy to power the data input device is either provided by its own power supply or is drawn from the host device.

FIG. 1b illustrates, the layout of the data input interface 10 which comprises user selectable zones or panels, e.g. 12, arranged to define one or more fixed points, e.g. 14. The depicted embodiment comprises a square grid of nine equal panels comprising three rows, each with three panels. Each of the outer panels has along its side a small run-off area 16 into and out of which the user can quickly move the stylus. Where the corners of the outer panels meet the corners of the inner panel is a small fixed point 14, or pin or guide pin, that serves as a guide to the movement of the stylus. The depicted embodiment also comprises a boundary 28 between each neighbouring panel.

In the depicted embodiment four panels are arranged around each fixed point. In other embodiments, each of the fixed points is a point around which three or more of the panels are arranged.

Sensors are provided on the data input device to record the movement of the stylus across the interface. Typically, at least one sensor to detect the movement of the stylus on each panel is provided.

The device is arranged to associate a sequential selection of two or more panels with an input code. The sequential selection comprises a clockwise and/or anticlockwise selection of the two or more panels around at least one of the fixed points. These clockwise or anticlockwise selections define part or full rotations around one or more fixed points. As can be seen, the panels are arranged to enable a sequential selection to be made while maintaining continuous contact with the data input interface. As can be seen sequential selections can be considered as sequential selections that consecutively select adjacent or neighbouring panels or zones.

When not in use the interface is in a dormant state and does not respond to the stylus. To commence operation the interface is either turned on with a switch or button or the stylus is placed on the middle panel. The processor 20 then becomes ready to record the movements of the stylus as it moves over neighbouring panels from a starting panel to an end panel making a sequential selection.

In typical operation the central panel is the starting point for a unique sequential selection or move or in other words the central panel has the focus. However, the device is able to accommodate a large number of unique moves by enabling each panel to take the focus and provide the starting point for another set of unique moves.

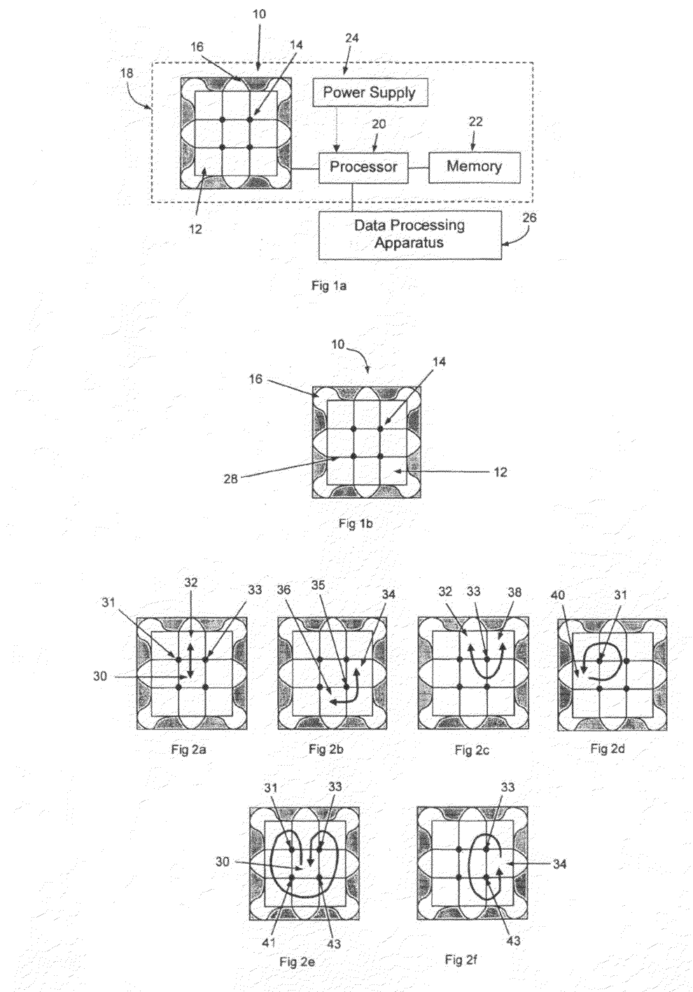

A unique move may begin and end with the selection of the same panel, as depicted in FIGS. 2a to 2f which illustrate some examples of unique sequential selections or moves made on the data processing interface.

FIG. 2a depicts a unique move starting in central panel 30, moving to upper central panel 32 and back again. This represents a clockwise then anticlockwise move of two panels around fixed point or pin 33 and, in this particular example, also represents an anticlockwise then clockwise move of two panels around fixed point 31.

FIG. 2b depicts a unique move starting in right central panel 34, moving through the corner panel to lower central panel 36 and back again. This represents a clockwise then anticlockwise move of three panels around fixed point 35.

FIG. 2c depicts a unique move starting in upper central panel 32, moving through the central panel, then right central panel to upper right corner panel 38 and back again. This represents an anticlockwise then clockwise move of four panels around fixed point 33.

FIG. 2d depicts a unique move starting in left central panel 40 and performing a full circular anticlockwise move around fixed point 31, ending back at panel 40 having moved over three other panels.

FIG. 2e depicts a unique move beginning and ending in central panel 30 having moved anticlockwise around all four fixed points 31, 41, 43 and 33 and having selected all of the outer panels on the way.

FIG. 2f depicts an anticlockwise selection of panels starting in right central panel 34, moving around fixed points 33 and 43 and returning to panel 34.

The input codes associated with each unique move are stored in memory 22 and processor 20 is arranged to process data received from the sensors to retrieve the associated input code from storage before sending the input code to data processing apparatus 26.

The device is arranged to associate each of a plurality of unique sequential selections with a corresponding input code of a plurality of input codes. These sequential selections may be predefined and/or user defined.

To change the focus from the central panel to an outer panel the stylus may be moved into the run-off area alongside the required panel. When the stylus moves from the run-off panel to the required panel this panel becomes the starting point and the processor starts to record the unique moves made by the user. Changing the focus is illustrated in FIG. 3 where the focus is changed from the central panel to the top left panel by making a move from central panel 30, anticlockwise around fixed point 31 to upper left panel 46, into run-off area 44 and back into upper left panel 46.

When the user wishes to move the focus again, the stylus may be moved into any run-off area. When this happens the focus immediately returns to the central panel. However, if the user wishes to make unique moves from a corner or edge panel then they can move the stylus into the run-off area alongside the desired panel, and when the stylus returns to the panel adjacent to this run-off area they can commence the required unique moves.

Once a unique move is completed the processor 20 identifies the unique move and finds within the memory store a code associated to that unique move. These stored codes are normally internationally recognised codes conforming to ASCII (American Standard Code for Information Interchange) or ANSI (American National Standards Institute) standards but may also be any code of the users choice or codes suited to or required by the host device. Once the required code is found it is then sent to the host device.

In basic operational mode the interface 10 recognises the completion of a distinct move when the stylus returns to the panel with the focus. However, basic operation can be enhanced so that in certain circumstances, modifications can be made to the unique, moves, which the processor 20 can also recognise as complete, unique moves.

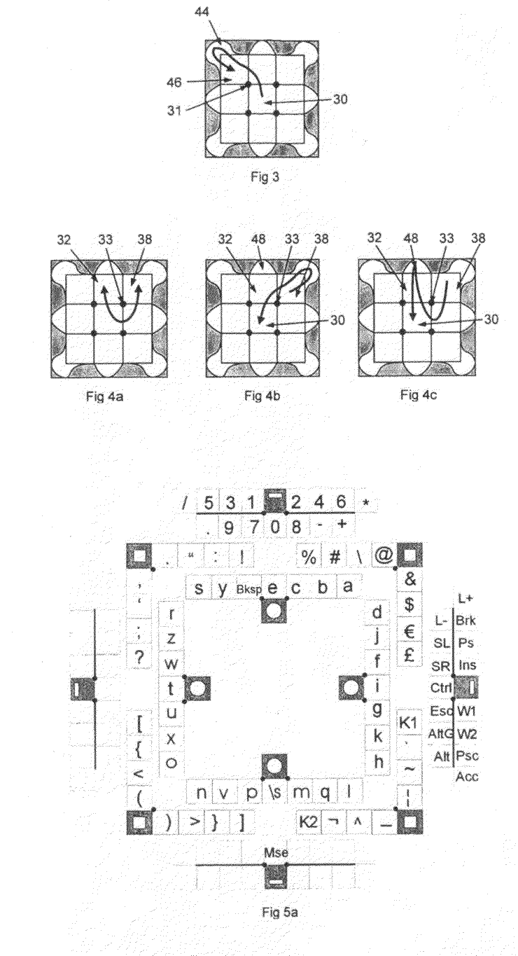

FIG. 4a shows a typical simple unique move to generate a particular code by moving clockwise from upper left panel 38 to upper central panel 32 around fixed point 33 and back again as shown. FIG. 4b shows how a simple unique move has been modified to generate the desired code but at the same time to return the focus to the central panel by moving from upper left panel 38 to upper central panel 32 around fixed point 33, into run-off area 48, over panel 32 into central panel 30.

In FIG. 4a a character is generated from the top right panel 38. The stylus is moved from the top right panel 38 in a clockwise direction around the associated fixed point or pin 33 for a three quarter turn and then back again to complete the move. If the user then wants to generate characters from the central panel they first turn off the focus of the top right panel 38 by moving into the run off area associated to the top right panel. This moves the focus immediately to the central panel and the stylus can now be moved to the central panel to commence a new move. This is illustrated in FIG. 4b.

The two moves illustrated in FIGS. 4a and 4b can be combined into one shortcut move as illustrated in FIG. 4c. The stylus is moved from the top right panel 38 in a clockwise move around the associated pin 33 for a three quarter turn. Instead of returning to the top right hand panel the stylus is moved into the nearest run of area and then directly to the central panel. This shortcut both generates the character that would have been generated if the move in FIG. 4a had been completed and also switches the focus to the central panel as if the move in FIG. 4b had been completed.

In another example the starting point for the next sequential selection can be changed in response to a specific modification of a particular sequential selection. For example, with reference to the numbering of the zones in FIG. 4b, a particular sequential selection of zones 38, 32, 30, 32, 38 can be modified to a selection of zones 38, 32, 30, 32, 30 to move the starting point from zone 38 to zone 30.

The above examples are ones where a zone can be set as a focus to identify the starting point for the next sequential selection and where a sequential selection can be associated with an input code and also move the focus from one zone to another zone.

Other moves can similarly be combined into shortcut moves.

A string of commands can be created and sent to the host device in one go. This enables the emulation of keyboard shortcuts, F-numbers, etc. For example to send the keyboard shortcut ‘Ctrl-b’ to the host device, the unique move is completed for the ‘Ctrl’ command, followed by the unique move for the character ‘b’ and when the unique move for the ‘Ctrl’ character is repeated the shortcut is considered to be complete and the codes for ‘Ctrl’ and ‘b’ are both sent to the host device.

As well as recognising characters from distinct moves across the panels, the device may be arranged to recognise the speed of certain movements. For example a particular code can be generated by moving the stylus into and out of a run-off panel twice in quick succession, followed by a pause.

If a stylus is used that is capable of detecting its separation from the input device interface then it is possible to allocate computer character and command codes to taps made on a single panel. For instance, if any panel is tapped twice in quick succession the last character is deleted.

After a period of disuse the interface resumes its dormant state, or it can be manually turned off using a switch or button.

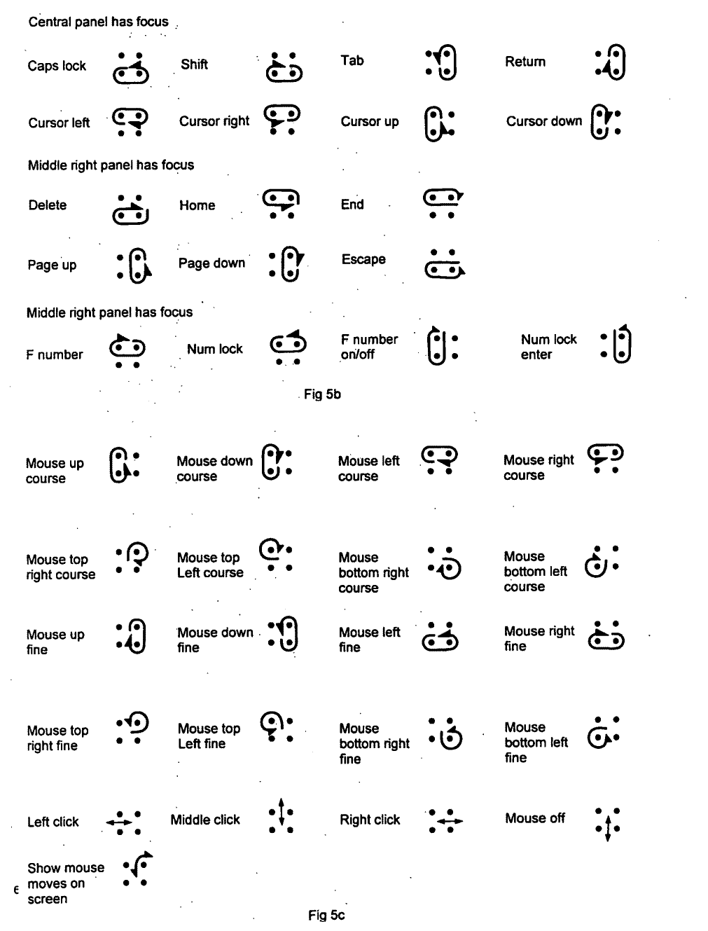

Examples of the input codes associated with unique moves from various panels are given in FIG. 5a. The notation shown in FIG. 5a may be enhanced with colour coding to increase ease of use. Users can quickly find which distinct move is required from which panel in order to generate their desired character or command from a reference diagram such as the one illustrated in FIG. 5a.

FIG. 5a shows, for one particular example for one embodiment, which character/code is sent to the computer once a particular rotation around a selected fixed point is executed. The shaded squares represent the panels of the data input device. Those squares containing a small white square represent the corner, those containing a white bar represent panels located on the edge of the device and squares containing a white circle represent the central panel. The shaded squares are laid out in positions relative to the panels they represent, thus the top most shaded square represents the top middle panel, the bottom left shaded square represents the bottom left panel, etc.

The small points attached to each square represent the fixed points adjacent to each panel.

The lists of characters/codes attached to each square show the characters/codes that can be generated using the corresponding panel as a starting point.

The shaded square towards the top right of the diagram represents the top right corner panel. Attached to this are two lists of characters:

%#\@ and &$ [symbol] £

The orientation of the list in relation to the fixed point gives the direction of the rotation around the fixed point. For example, to reach the % sign the user should move from the square into the list to the left of the square. This requires an initial anti-clockwise movement around the associated fixed point.

The order of the characters shows the degree of rotation around the fixed point required to generate a particular character. The % sign is the fourth character in the list so four quarter turns or one full turn (across all four panels) is required to generate the % sign.

To generate the dollar sign the diagram shows that the user should start from the top right panel, move in an anti-clockwise direction two quarter turns, (across two panels). As the move is completed by returning to the starting panel these steps are retraced.

The backspace command—Bksp—used to delete the last character is shown in the list towards the top of the diagram. The attached square contains a circle indicating that the user should start from the central panel. To reach Bksp the user should move around the fixed point situated in the top left corner of the central panel in an anti-clockwise direction two quarter turns (across two panels) and back again to complete the move.

The character “e” is situated directly above the square representing the central panel and only requires a quarter turn around the fixed point (one panel) and back. In this situation the rotation can be regarded as being around either of the fixed points.

In examples where the starting point does not have the focus, the user should first set the focus to the panel that is to be used as the starting point of the move.

Memorising the moves is made easier as they are grouped according to type. For example, all letters are generated from the central panel. Numbers are generated from the top edge square, control commands are generated from the right edge square, punctuation from the top left, symbols from the top right, brackets from the bottom left and technical characters from the bottom right.

Multipin moves around multiple fixed points or pins are shown separately in FIG. 5b and moves to provide cursor control are shown in FIG. 5c.

In the memory, the panel sequence (typically the sensor sequence) for each unique move is stored associated, with the corresponding input code, e.g. an ASCII or ANSI code or a keyboard code (e.g. a manufacturer's keyboard code), for the corresponding character/code. For example, the panel sequence and corresponding input code can be stored as a table or list.

A wide variety of code sets can be stored in the memory and retrieved by the processor. The user can switch from one code set to another giving the data input device almost limitless versatility. These code sets can enable the data input device to:
Provide cursor control similar to a mouse or tracker ball
Access an address book or other record set
Generate database queries
Input musical notation
Provide drawing and other graphical tools
Accommodate large sets of character codes such as those required by Chinese and other pictorial languages.
Send application specific shortcuts and custom commands
Control games and other entertainments
Remotely control toys, machines, equipment and instrumentation
Hold frequently used words, parts of words and phrases.
Access shortcuts to macros
Access shortcuts to applications
Store encrypted passwords or digital signatures

As well as standard default unique moves, users can define their own unique moves and/or allocate their own choice of codes to the unique moves.

The data input interface is operated with simple handwriting like movements and the unique moves combine to enable the user to use flowing, economic movements, effectively creating a style of non-linear handwriting unique to the data input interface. FIG. 6 illustrates this with three unique moves combined, which in the preferred implementation would send the word ‘the’ to the host device.

Referring to FIG. 6, the part of the move from panel 30 to 40 and back again is associated with the input code for “t”, the next part of the move from panel 30 around fixed point 43 is associated with the input code for “h” and the last part of the move from panel 30 to panel 32 and back is associated with the input code for “e”.

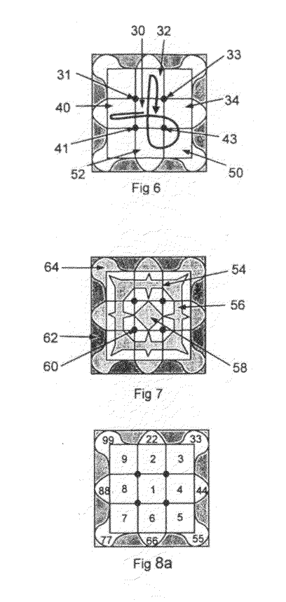

Control of the interface may be assisted by simple tactile features as illustrated in FIG. 7. With the aid of these tactile features the interface can be operated without visual contact. Where the edges of the inner panels meet is a guide 54 (e.g. a groove) to provide tactile feedback to the user. The run-off areas 64 are slightly raised so that the user can sense with the stylus the edges of the panelled area. The whole interface is slightly sunken so that the user can feel with the stylus the perimeter of the interface. The panels contain guides 56, 58 (e.g. shallow indents) that help guide the movement of the panel and assist tactile feedback so that the user can feel the movement across each panel. The areas around the fixed points 60 are slightly raised.

In another embodiment, the run-off areas 64 are not raised and may be, for example, a slot in a raised area surrounding the panels. The stylus can move in and out of such slots, the surface of the run-off area being level with the surface of the panels.

In most cases the stylus is moved across the surface in continual contact, but the same results can be achieved simply by touching the right panels in the right order. Also, for example, a stylus that uses a light beam or radio transmission to a sensor in each panel may be used and in such an arrangement the stylus may not maintain continual contact.

The user can customise a variety of features or select particular options. For example;
Language—For roman font languages this option adds to the interface unique moves for any accents or special characters required by the language choice. For non-roman fonts a suitable set of move definitions replaces, the default English definitions.
Speed of mouse moves—Increase or decrease the speed of movement of the cursor during mouse emulation moves.
Add audio tones to each panel that sound when the panel has focus.
Add audio tones to key functions and commands such as turning the interface on or off, page return, delete, etc.
Turn on or off text prediction program, auto capitalisation, auto spacing and other support software.
Turn on or off recognition of shortcuts such as those shown in FIGS. 4a and 4b.
Turn on or off facility to recognise time dependent moves made into run off-areas. For example, the generation of the space character by moving the stylus quickly in and out of a run off area twice followed by a pause.
The user can select or define any unique move and add their own computer code(s) to that move, allowing full customisation of the interface.

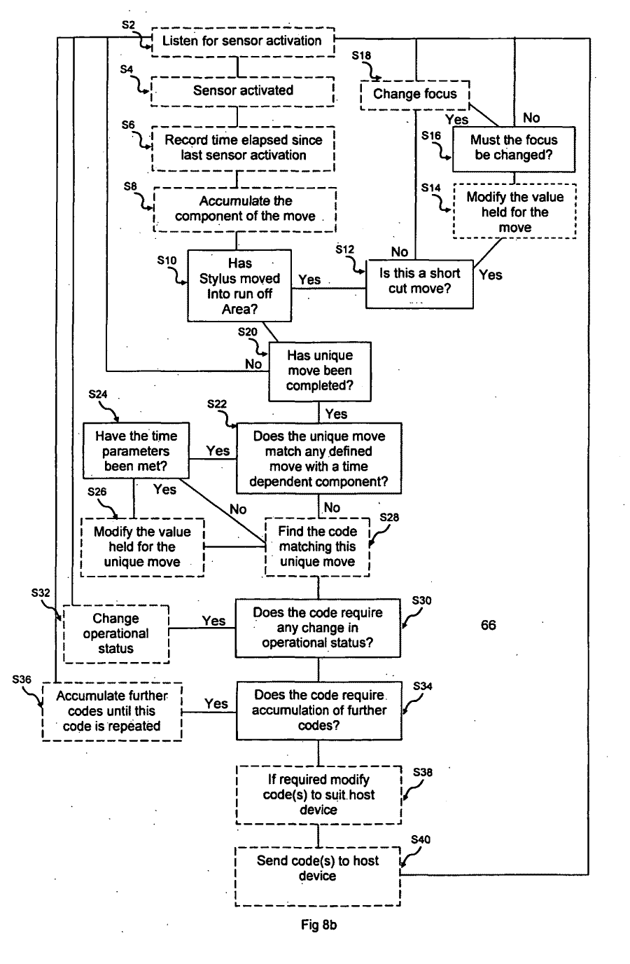

The sensor layout, how the sensors are identified, the data stored in memory and how the logic, e.g. as computer code or software, processes the received signals from the sensors and uses the data stored in the memory to convert the moves on the interface sensed by the sensors into a character/code in one example embodiment will now be described with reference to FIGS. 8A and 8B. FIG. 8A shows the numerical values assigned to each sensor and FIG. 8B is a flow diagram showing the steps which the processor is arranged to perform, in this embodiment as computer code or software.

Referring to FIG. 8A, sensors in the interface detect movement stylus movement and in this embodiment send a unique number to the processor which is arranged to identify the panel in contact with the stylus. The panels and run-off areas are numbered as in FIG. 8A.

The run-off areas have double digit numbers, each digit corresponding to the number of the associated panel. The processor is arranged to determine from a received number, the number of digits received and therefore whether a panel or a run-off area has been touched. By extracting one digit from a two digit number the controller identifies the panel associated to the run-off area. The order of the numbers sent cause flags to be set, controlling the process flow (FIG. 8). The main flags, which are stored in memory, are shown in italics below:

| | |
|---|---|
| Start | Indicates the activation of the interface ready for use. |
| Record | Record the numbers of the panels touched by the stylus. |
| Time | The time component of a move. |
| SetFocus | The number of the panel with the focus. |
| StartSq | The number of the panel from which the move starts. |
| RunOff | Indicates if a run-off area has been activated. |
| EndMove | Indicates the end of a move. |

When the interface is activated the flags are set as in list 1 below.

| | |
|---|---|
| Start | True (Start remains True until the interface de-activates) |
| Record | True |
| Time | 0 |
| SetFocus | 1 |
| StartSq | 1 |
| RunOff | False |
| EndMove | False |

When executing a simple move from the central panel the processor is arranged to cycle through steps S2 to S20 of FIG. 8B. Once the move is complete and the flow has reached S20 of FIG. 8B the flags are set as in list 2 below.

| | |
|---|---|
| Record | True |
| Time | A number indicating the time component |
| SetFocus | 1 |
| StartSq | 1 |
| RunOff | False |
| EndMove | True |

While executing the move panel numbers are accumulated in memory as a string ‘String’. The processor is arranged to recognises that EndMove is True and proceeds to step S28. Here the value in String is matched against a list of computer codes to find the code that is allocated to the unique move executed. If the user had moved a full clockwise circle around the top right pin, String would hold the value ‘12341’. In this embodiment the code allocated to this unique move is 97, the ASCII value for lower case ‘a’.

Further examples of code allocations in this embodiment include:

| | Value in | | |
|---|---|---|---|
| Move | String | ASCII code | Character |
| ¼ clockwise around top left | 929 | 46 | Full Stop |
| point from top left panel | | | |
| ½ clockwise around bottom | 78187 | 60 | < |
| left point from bottom left | | | |
| panel | | | |
| ¾ anti-clockwise around | 1654561 | 81 | Lower case q |
| bottom right point from | | | |
| central panel | | | |
| Full turn anti-clockwise | 21432 | 43 | + |
| around top right point from | | | |
| top centre panel | | | |

A list containing the values storing the “Value in String” and “ASCII code” values is stored in memory.

If a run-off area is entered the flow moves to S10 of FIG. 8B. If the run-off area is used to change the focus then S12 sets the flags as in list 3 below and sets String to null

| | |
|---|---|
| Record | False |
| Time | 0 |
| SetFocus | The number of the panel to be given the focus |
| StartSq | 0 |
| RunOff | True |
| EndMove | False |

Run-off areas are also used in shortcut moves. FIG. 4c shows a shortcut move that generates a character from the top right panel and then switches the focus to the central panel. When the stylus enters the run-off area String will hold the values 341222. At step S12 the processor matches this against a list and identifies it as a short cut move. At step S14 the processor modifies String to hold 3412143. At step S16 RunOff is True so the focus is changed. When the cycle reaches S2 the flags, are set as in list 4 below.

| | |
|---|---|
| Record | False |
| Time | A number indicating the time component |
| SetFocus | 1 |
| StartSq | 0 |
| RunOff | False |
| EndMove | True |

Movement of the stylus to the central panel executes steps S2 to S20 at which point as EndMove is True the cycle continues to S28. Here 3412143 is found to match ASCII code for the euro sign and this is sent to the host device.

Although reference has been made above to several of the steps of the flow chart of FIG. 8B, for completeness each of the steps will be described in turn. The boxes in the flow chart of FIG. 8B illustrate the steps which the processor is arranged to perform on receipt of the signals sent from the sensors of the interface.

Referring to FIG. 8B, at step S2 the processor listens for a sensor activation (i.e. it is in a ready state to receive a signal from a sensor). At step S4 a sensor is activated. At step S6 the time elapsed since the last sensor activation is recorded and at step S8 the processor accumulates (i.e. stores) the component of the move in String.

At step S10 the processor determines if the signal corresponds to a run-off area. If so, at step S12 the processor determines if this is a shortcut move.

If the determination at step S12 is negative, then at step S18 the processor changes the focus. If the determination at step S12 is positive, then at step S14 the value held for the move is modified. Then at step S16, a determination of whether or not the focus must be changed is made. If so, flow moves to step S18 and the focus is changed. Otherwise, flow moves to back to step S2.

If the determination at step S10 is negative, flow moves to step S20 which determines whether a unique move has been completed. If not, flow moves back to steps S2.

If the determination at step S20 is positive, the processor checks at Step S22 to see if the unique move matches any defined move for which a time dependent component exists. If not, flow moves to step S28.

If the determination at step S22 is positive, the processor checks at step S24 whether the time parameters have been met. If not, flow moves to step S28.

If the check of step S24 is positive, at step S26 the value held for the unique move is modified. Flow then moves to step S28.

At step S28, the code matching the unique move is located from the list in memory.

At step S30, a determination of whether the code requires any change in operational status (e.g. as for a caps lock code). If so, at step S32 the operational status is changed before returning to step S2.

If the determination at step S30 is negative, at step S34 a check of whether the code requires accumulation of further codes is made (e.g. as for a ‘ctrl’ code). If so, at step S36 further codes are accumulated until this cumulative code is repeated.

If the determination at step S34 is negative, if required, the processor modifies the code to suit the host device at step S38. Then, at step S40, the code is sent to the host device.

A computer program comprising computer code to perform the processing steps may be provided. The computer program may be provided on a carrier medium (e.g. a disk or an electronic signal).

Variations to the embodiments described with reference to FIGS. 1 to 8 may be made.

For example, the selection element (e.g. a stylus) may sense its own movement over the panels. In such an embodiment, sensors built into the interface are not required.

Other input elements such as contact areas, buttons, switches, etc. may be placed around one or more sides of the interface which when touched initiate a common action such as caps lock, delete, space, etc. These contact areas, buttons, switches, etc. may consist of a single device running the full length of the side of the interface or may be divided into multiple devices. This is illustrated in FIG. 9.

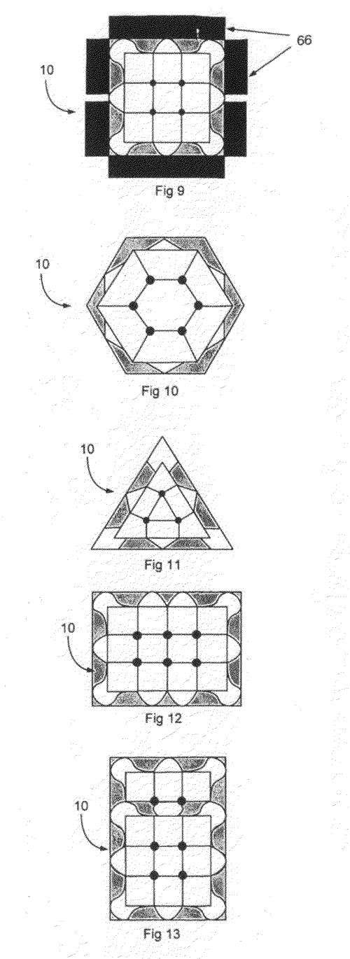

The data input interface may be have a greater number of fixed points arranged around the central panel creating more directions of movement, allowing a greater number of distinct moves. This is illustrated in FIG. 10.

Alternatively the data input interface may have a reduced number of fixed points around the central panel, reducing the directions of movement and providing a reduced number of unique moves. This is illustrated in FIG. 11.

The data input device may have additional rows of fixed points with an accompanying addition of panels to enable movements to be made from a greater number of starting points and may combine rotations around the fixed points, thus providing more distinct moves. This is illustrated in FIG. 12.

The run off areas may be extended to provide additional fixed point(s) and/or additional panel(s) to provide additional unique moves. This is illustrated in FIG. 13.

The pins marking the fixed points may not necessarily be round, they could be elliptical or other shapes, for example to provides better guidance for the stylus.

A larger version of the interface may be provided for users unable to manipulate a small stylus such as the physically disabled or users wearing heavy gloves.

The interface may be activated by other selection elements, for example a finger.

A small liquid crystal display (LCD) window near the data input device may be incorporated to show the data item sent to the host device once a move was completed and to also show which panel has the focus.

The panels may be made from a transparent of translucent material and the panel with the focus may be illuminated or coloured from behind.

If a stylus is used that is capable of detecting its separation from the input device interface then it is possible to allocate computer character and command codes to taps made on a single panel. For instance, if any panel is tapped twice in quick succession the last character is deleted.

In the preferred embodiment the shift key is only used to enable capitalisation. However it could also be used to enable a second character, symbol, command, etc. to be added to the unique moves in the same way as it does in a conventional PC keyboard.

The fixed points may be virtual fixed points and not be marked on the surface of the interface, thus a standard graphic tablet could be used to mimic the operation of the interface, requiring only a few simple markings to delimit the panel boundaries. In such an embodiment, diagonal moves over the fixed points are possible.

Panels and run off-areas can also be buttons or a form of switch, clicked by a firm increase in pressure from the stylus, or the same effect can be achieved if the panels are made from a material sufficiently sensitive to the changes in pressure. Additionally or alternatively, suitable sensors may be placed elsewhere in the interface such as within the fixed points or pins, in the interface boundary and/or in the panel boundaries.

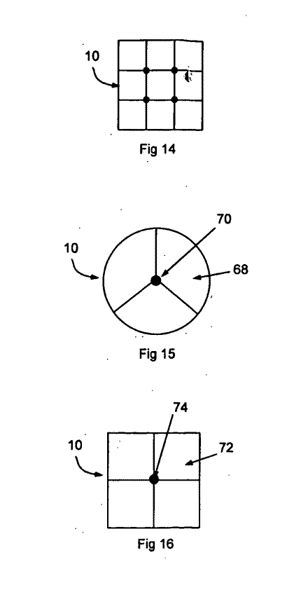

The interface 10 may have no run-off areas as shown in FIGS. 14 to 16. the interface may be a simple design, for example with only one fixed point 70 and three panels 68 as shown in FIG. 68 or one fixed point 74 and four panels 72 as shown in FIG. 16.

The description of the above embodiments have been given by way of example only. Variations to the described embodiments may be made within the scope of the invention.

1. A data input device comprising:
a data input interface comprising user selectable zones arranged to define one or more fixed points, each of the fixed points being a point around which three or more of the zones are arranged;
wherein the device is arranged to associate each of a plurality of unique sequential selections of two or more zones with a corresponding input code of a plurality of input codes, wherein a sequential selection comprises a clockwise and/or anticlockwise selection of the two or more zones around at least one of the fixed points; and
wherein one or more sequential selections each begin and end with the same zone and comprise a selection of two or more zones in a clockwise direction around a fixed point followed by a retraced selection of the same two or more zones in an anticlockwise direction around the same fixed point, or alternatively a selection of two or more zones in an anticlockwise direction around a fixed point followed by a retraced selection of the same two or more zones in a clockwise direction around the same fixed point, to identify a single character or command.

2. (canceled)

3. A data input device according to claim 1, wherein the zones are arranged to enable a sequential selection to be made while maintaining continuous contact with the data input interface.

4. A data input device according to claim 1, wherein one or more of the zones include a guide extending towards one or more other zones.

5. A data input device according to claim 4, wherein the guide is a groove.

6. A data input device according to claim 1, wherein the data input device has a raised area around each of the fixed points.

7. (canceled)

8. A data input device according to claim 1, wherein the plurality of unique sequential selections are predefined.

9. A data input device according to claim 1, wherein the zones are arranged to enable a plurality of sequential selections to be made while maintaining continuous contact with the data input interface.

10. A data input device according to claim 1, wherein the zones are arranged to define a plurality of fixed points and the device is arranged to associate a first sequential selection around a first fixed point with a corresponding first input code and to associate a second sequential selection around a second fixed point with a corresponding second input code, wherein the first sequential selection and the second sequential selection comprises the same clockwise and/or anticlockwise selection of zones around the respective fixed point.

11. A data input device according to claim 1, wherein the zones are arranged to define a plurality of fixed points and the device is arranged to associate a sequential selection with an input code, wherein a sequential selection comprises a clockwise and/or anticlockwise selection of the zones around two or more of the fixed points.

12. A data input device according to claim 1, wherein the zones include a central zone surrounded by a plurality of outer zones.

13. A data processing device according claim 12, wherein the starting zone for a sequential selection is the central zone.

14. A data input device according to claim 1, wherein the zones are arranged to be selected by a stylus.

15. A data input device according to claim 1, wherein one or more of the outer zones has an associated user selectable run-off area, wherein the user selectable run-off area is selectable to indicate that the associated outer zone is to be used as the starting point for the next sequential selection.

16. A data input device according to claim 14, wherein the one or more run-off areas are raised in relation to a surface of the zones.

17. A data input device according to claim 1, wherein the device comprises one or more further input elements for use in combination with the zones.

18. A data input device according to claim 1, wherein the device comprises a grid of nine zones with four fixed points and eight run-off areas.

19. A data input device according to claim 1, wherein the device includes a processor and memory, wherein the memory stores a set of sequential selections and a set of associated input codes and the processor is arranged to process data representing a unique sequential selection by retrieving the associated input code stored in memory.

20. An apparatus comprising a data input device according to claim 1 and a processor and memory, wherein the memory stores a set of sequential selections and a set of associated input codes and the processor is arranged to process data representing a unique sequential selection by retrieving the associated input code stored in memory.

21. A device according to claim 19, wherein the device comprises one or more run-off areas and the processor is arranged to change the starting point for the next sequential selection in response to the selection of a run-off area or wherein the processor is arranged to change the starting point for the next sequential selection can in response to a specific modification of a particular sequential selection.

22. A device according to claim 19, wherein the device or apparatus has multiple operational statuses and the processor is arranged to change the operational status in response to a sequential selection associated with an input code which is a modification code.

23. A device according to claim 19, wherein the processor is arranged to accumulate further codes in response to a sequential selection associated with an input code which is a cumulative code.

24. A device according to claim 19, wherein the device or apparatus comprises a processor and wherein the processor is arranged to process data representing a sequential selection which includes a time dependent component.

25. A device according to claim 1, wherein the input codes are in a standard code such as an ASCII code or ANSI code or wherein the input codes are in a manufacturer's keyboard code.

26. (canceled)

27. A device according claim 1, wherein a sequential selection comprises a full clockwise and/or full anticlockwise consecutive selection of zones around at least one of the fixed points.

28. A device according to claim 1, wherein the device is arranged so that different zones can provide the starting point for a sequential selection.

29. A device according to claim 28, wherein a zone can be set as a focus to identify the starting point for the next sequential selection and wherein a sequential selection can be associated with an input code and also move the focus from one zone to another zone.

30. A device according to claim 1, wherein the zones are panels.

31. (canceled)

32. A data input device comprising:
a data input interface comprising user selectable zones arranged to define one or more fixed points, each of the fixed points being a point around which three or more of the zones are arranged;
wherein the device is arranged to associate a sequential selection of two or more zones with an input code, the sequential selection comprising a clockwise and/or anticlockwise selection of the two or more zones around at least one of the fixed points;
wherein one or more of the outer zones has an associated user selectable run-off area, wherein the user selectable run-off area is selectable to indicate that the associated outer zone is to be used as the starting point for the next sequential selection.

33. A computer program on a carrier medium, the computer program comprising computer code to process a unique sequential selection received from a data input device comprising a data input interface comprising user selectable zones arranged to define one or more fixed points, each of the fixed points being a point around which three or more of the zones are arranged, wherein the device is arranged to associate each of a plurality of unique sequential selections of two or more zones with a corresponding input code of a plurality of input codes, wherein a sequential selection comprises a clockwise and/or anticlockwise selection of the two or more zones around at least one of the fixed points; and wherein one or more sequential selections each begin and end with the same zone and comprise a selection of two or more zones in a clockwise direction around a fixed point followed by a retraced selection of the same two or more zones in an anticlockwise direction around the same fixed point, or alternatively a selection of two or more zones in an anticlockwise direction around a fixed point followed by a retracted selection of the same two or more zones in a clockwise direction around the same fixed point, to identify a single character or command, the computer code being arranged to retrieve from a memory an input code associated with the unique sequential selection.

34. A data input device according to claim 1, wherein the panels are arranged to be selected by a finger.
